(19) United States
(12) Patent Application Publication
(10) Pub. No.: US 2004/0227018 A1
(43) Pub. Date: Nov. 18, 2004

(54) Modular fuel injector for an internal combustion engine

(75) Inventor: Klaus Seelbach, Grand Rapids, MI (US)

Correspondence Address: BROOKS KUSHMAN P.C., 1000 TOWN CENTER, TWENTY-SECOND FLOOR, SOUTHFIELD, MI, 48075, US

(73) Assignee: ROBERT BOSCH FUEL SYSTEMS CORPORATION, Kentwood, MI

(21) Appl. No.: 10/438,499

(22) Filed: May 15, 2003

(51) Int. Cl. F02M 47/02; B05B 1/30; F02M 61/00; F02M 59/00

(52) U.S. Cl. 239/533.2; 239/533.3; 239/585.1; 239/88

(57) ABSTRACT

A fuel injector comprising a pumping chamber pressurized by an actuator responsive to an engine controller for delivering pressurized fuel from the pumping chamber to a control valve module to control pressure applied at the outlet of an injector nozzle. The control valve module includes at least one control valve. Valve actuators are in a stator core plate that is independent of the control valve module. Machining operations during manufacture of the injector are simplified by a separation of the stator core plate and the control valve module. Mating, juxtaposed surfaces of the control valve module and the stator core plate are fixed by an indexer.

### BACKGROUND OF THE INVENTION

1. Field of the Invention

The invention relates to a control valve assembly with either one or two control valves designed as an independent modular unit for a high-pressure fuel injector for an internal combustion engine, particularly diesel engines.

2. Background Art

A fuel injector for an internal combustion engine such as a diesel engine, which includes a unitary control valve module with a single control valve and a single stator core in aligned, stacked relationship with respect to an injector body and a nozzle assembly, is disclosed in copending U.S. patent application Ser. No. 10/197,317, filed Jul. 16, 2002. That application is assigned to the assignee of the present invention. Injectors of this kind comprise precisely machined components or modules that can be assembled with minimum fuel leakage using efficient assembly steps during manufacture. The injector precisely controls the quantity and the timing of the fuel injected into the combustion chamber of an internal combustion engine under the control of an electronic engine controller. The injection events are matched to the engine cycle to provide minimum brake specific fuel consumption and to reduced undesirable exhaust gas emissions.

Fuel injectors of the kind disclosed in the copending patent application identified above include a high-pressure pump plunger that is stroked by a cam follower driven by a camshaft for the engine. The plunger cooperates with a plunger bore in a pump body to define a pumping chamber that is in communication with a control valve. The control valve is movable between an open position and a closed position to establish pressure pulses in a nozzle assembly of the injector. The valve is carried by an actuator armature situated adjacent an electromagnetic stator in a stator core plate. As the engine controller varies the current of stator windings, variable forces are transmitted to the control valve to effect appropriate shaping of fuel flow rate during each injection event to achieve optimum engine performance with reduced undesirable engine exhaust emissions.

German Patent Publication WO 02/3142 A1 and copending U.S. patent application Ser. No. 10/196,894, filed Jul. 16, 2002, disclose fuel injectors having two control valves, each of which is controlled by a separate electromagnetic valve actuator. That copending application also is assigned to the assignee of the present invention. The manufacture of such dual valve injectors, as well as single valve actuators, requires precise, close-tolerance machining of valve body surfaces and drilling of multiple pressure passages. The passages typically are relatively long, which increases the manufacturing difficulties. In dual valve injector assemblies of the kind shown in copending U.S. patent application serial No. 10/196,894, the actuators are assembled within a common control valve body. This presents a further manufacturing problem because of the difficulty in accessing critical surfaces of the control valve body that must be machined.

### SUMMARY OF THE INVENTION

The present invention simplifies the manufacture of an injector by replacing costly and highly demanding grinding operations in bores by easily manufacturable flat grinding operations. Since the now shorter control valve module allows for different drilling angles, sharp deflections of fuel columns with the resulting hydraulic disadvantages can also be avoided. Further, unlike manufacture of known injector designs, ECM operations are not required to smooth and round the intersections of connecting bores. This contributes significantly to module strength and durability.

Particularly with dual control valve designs, routing and attaching electrical coil lead wires to an external connector is not as challenging with the design of the present invention. A separate stator core plate facilitates this because the magnet cores are still accessible after installing the stator core plate into the injector body. The coil lead wires then can be readily attached to external connector wires; e.g., by crimping or welding.

With the design of the present invention, each control valve seat is closer to the control valve module surface. This allows for the use of more rigid grinding tools, resulting possibly in smaller tolerances of the control valve seat geometry in the control valve module. Because the stator core plate is separate from the control valve module, it is also possible to integrate the stator core plate into the injector body. This would eliminate another demanding grinding process in a bore. However, the control valve stroke of at least one control valve would need to be set with a categorized shim during the assembly process rather than grinding the stroke into the valve during the grinding process.

The injector of the present invention comprises a control valve module that is independent of actuators of an actuator module or stator core plate. The control valve module is situated in stacked, adjacent relationship with respect to a guide plate adjacent a nozzle nut assembly. The stator core plate, the control valve module, the guide plate and the nozzle nut assembly are assembled together with an injector body to form an integrated fuel injector.

The control valve module can be machined prior to assembly of the injector in a separate machining operation. The guide plate is interposed between the nozzle nut assembly and the control valve module, the relative angular position of one with respect to the other being indexed so that passages formed in the control valve module are aligned with passages formed in the guide plate, the latter being separately machined.

### BRIEF DESCRIPTION OF THE DRAWINGS

FIG. 1 is a cross-sectional assembly view of a dual valve injector of the kind disclosed in copending patent application Ser. No. 10/196,894, previously identified;

FIG. 2 is a cross-sectional view of a control valve module and a stator core plate, which may be assembled in a manner similar to the assembly of the design of FIG. 1; and

FIG. 3 is an end view of the valve body of FIG. 2 as seen from the plane of section line 3-3 of FIG. 2, wherein the underside of the valve module body is illustrated.

### DETAILED DESCRIPTION OF THE PREFERRED EMBODIMENT

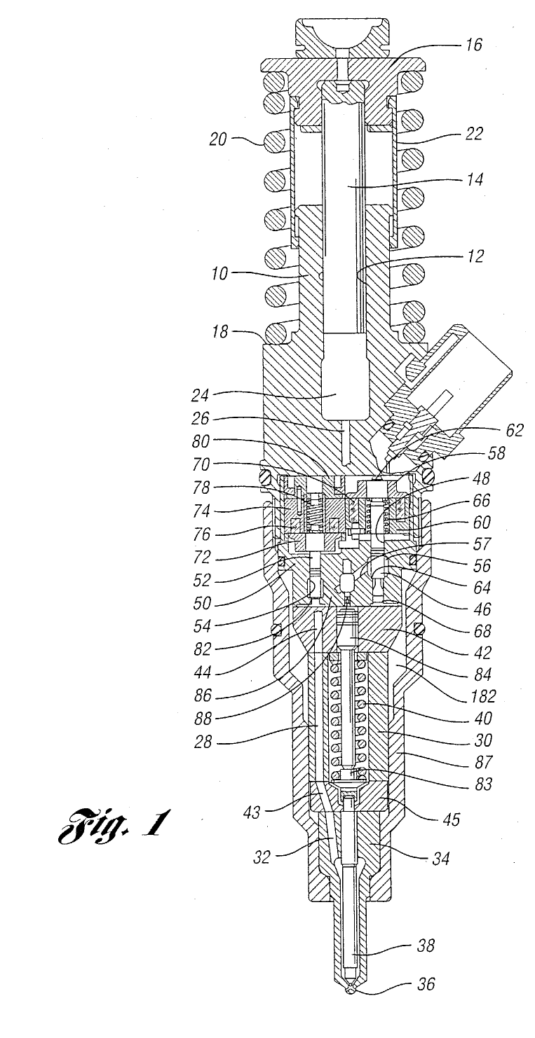

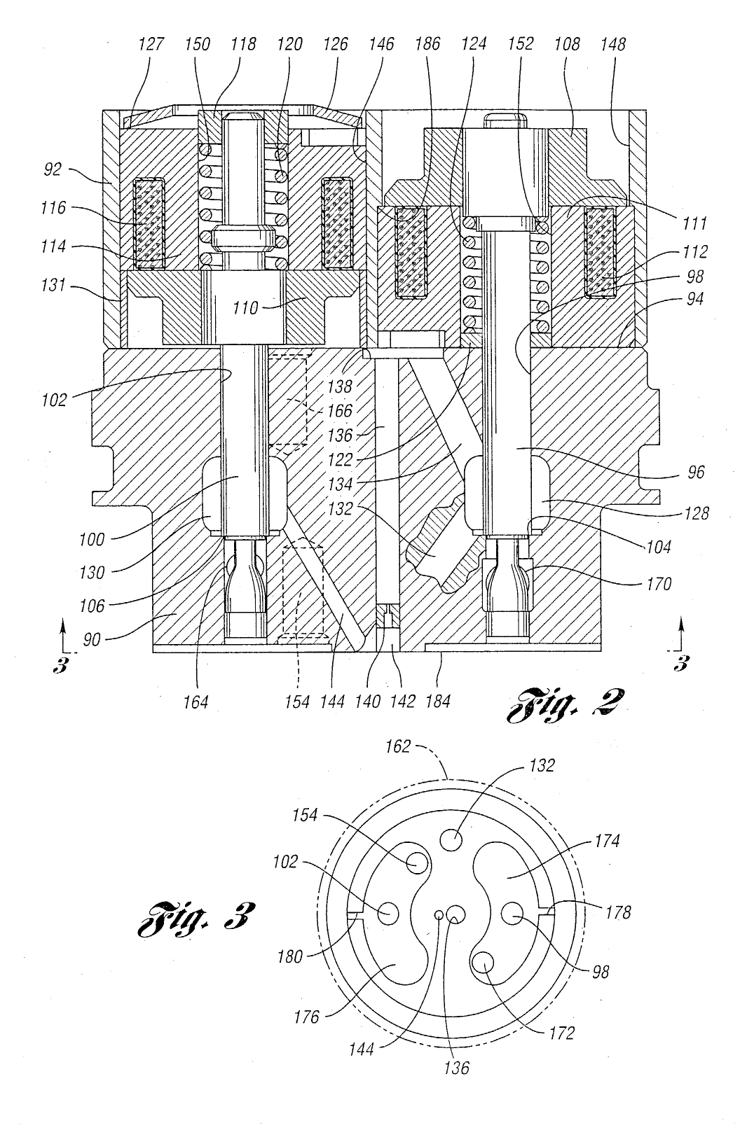

To provide an understanding of the mode of operation of the fuel injector of the invention, reference first will be made to the injector of FIG. 1. The injector of FIG. 1 does not include the features of the invention illustrated in FIG. 2, but the mode of operation of the injector of FIG. 1 is generally common to the mode of operation of the injector of the invention.

The design of FIG. 1 includes an injector body 10, which has a cylindrical plunger bore 12 in which a pump plunger 14 is situated. The upper end of the plunger 14 carries a cam follower assembly 16, which is engaged by an engine camshaft-operated actuator (not shown). A spring seat 18 formed on body 10 is engaged by plunger spring 20, the upper end of which engages cam follower 16. Cam follower guide 22 is located within the spring 20.

The cylindrical bore 12 and the plunger 14 define a high pressure pumping chamber 24, which is in fluid communication with high pressure delivery passage 26. This passage communicates with passage 44 in guide plate 42, with passage 28 in spring cage 30, with passage 43 in stop plate 45 and with nozzle passage 32 in nozzle body 34.

Fuel injection orifices 36 are formed in the tip of nozzle body 34. They are opened and closed by a nozzle needle valve 38. A nozzle spring 40, which is seated on guide plate 42, urges needle valve 38 in a downward direction as viewed in FIG. 1. Guide plate 42 has a passage 44, which communicates with the previously described high pressure delivery passage 26.

A first control valve 46, hereinafter referred to as the main control valve, is positioned in a valve bore 48 in control valve body 50. A second control valve 52, hereinafter referred to as the nozzle control valve, is positioned in valve bore 54.

Passage 26 communicates with annular space 56 adjacent main control valve 46 through internal passage 57. Main control valve 46 carries an armature 58 positioned directly adjacent a stator 60 with an air gap there between. When the actuator for main control valve 46 is de-energized, the valve is open and the valve stroke is limited by a stop 62 on the upper side of the armature 58. Annular space 56 has a valve seat 64 on control valve body 50. When the stator 60 is activated, main control valve 46 is urged against the valve seat 64. When the stator 60 is deactivated, spring 66 shifts main control valve 46 to the open position, thereby allowing pressurized fluid in passage 26 to be connected to a spill passage 68. The solenoid windings for the stator 60 are shown at 70.

Nozzle control valve 52 is connected to second armature 72, which is situated directly adjacent second stator74. The windings for stator 74 are shown at 76. Valve spring 78, seated on stator valve plate 80, urges the armature 72 and the nozzle control valve 52 in a downward direction, which closes the control valve 52 against valve seat 82. Thus, the control valve 52 normally is closed by the valve spring 78 against the valve seat 82 when the windings 76 are de-energized.

The guide plate 42 receives a needle piston or needle valve load pin 84 situated in a piston opening. Load pin 84 extends downwardly and engages a spring seat for nozzle needle valve 38, as shown at 83. A pressure chamber on the upper side of the needle valve load pin 84 communicates with high-pressure annular space 54 for nozzle control valve 52 through passage 86.

Passage 26 communicates, as explained before, with annular space 56 for main control valve 46. It also communicates with the upper side of the needle valve load pin 84 through a flow restricting passage 88.

Unlike the design shown in FIG. 1, the design of FIG. 2, which incorporates the teachings of the invention, includes a control valve module body 90, which is separate from actuator module body or stator core plate 92. The control valve module body and the stator core plate are situated in face-to-face, juxtaposed relationship at an interface shown at 94 when they are assembled in the injector assembly. The interface at 94 can be machined by a single grinding operation throughout the entire width of the control valve module body 90.

A nozzle nut or nozzle housing of the kind shown at 87 in FIG. 1 encloses control valve module body 90 and stator core plate 92.

As seen in FIG. 2, a main control valve 96 is situated in valve bore 98, and a nozzle control valve 100 is situated in valve bore 102. Main control valve 96 has a valve land that engages valve seat 104, and nozzle control valve 100 has a valve land that engages valve seat 106. Main control valve 96 is connected to actuator armature 108, and nozzle control valve 100 is connected to actuator armature 110. Armature 108 is positioned adjacent the pole face of stator 111, which has stator coil windings 112. Armature 110 is situated adjacent the pole face of stator 114, which has stator coil windings 116.

A valve shim 118 carried by nozzle control valve 100 at the upper end of the valve acts as a seat for valve spring 120. Similarly, a valve shim 122 may be provided for main control valve 96 against which valve spring 124 is seated. A washer spring 126, is seated against an injector body or against a stator valve plate corresponding to stator valve plate 80 of FIG. 1 when the stator core plate and the control valve module are assembled. It engages the top of stator 114, as shown at 127. Stator 114 thus is urged against a calibrated spacer shim 131 so that the armature 110 and the stator 114 are precisely positioned with respect to the ground surface 94 on the control valve module body. The injector body corresponds to the injector body 10 of FIG. 1. The outline of the injector body is shown in FIG. 3 at 162.

When the armature 108 is driven toward the pole face of stator 111 as the windings 112 are energized, the valve 96 is closed against the valve seat 104. Annular space 128 for main control valve 96 is pressurized by high pressure. It is connected to a passage corresponding to passage 26 in the injector of FIG. 1 through internal passage structure (not shown in FIG. 2) in control valve module body 90. Annular space 128 communicates with fuel injector nozzle feed passage 132, which communicates with a passage corresponding to passage 28 seen in FIG. 1. Annular space 128 communicates also with passage 134, which in turn communicates with passage 136 through recess 138 machined in the top surface of the valve module body at interface 94. A flow restriction 140 in passage 136 is calibrated to provide a reduced and controlled pressure buildup in passage 142, which in turn communicates with passage 144 extending from the annular space 130 for the nozzle control valve 100. Passage 142 communicates with the upper surface of a needle load pin of the kind shown at 84 in FIG. 1.

The stator core plate 92 has separate openings 146 and 148, which receive, respectively, the stator and the armature for nozzle control valve 100 and the stator and armature for valve 96. The stator for valve 100 has a central opening 150, which receives the spring 120, and the stator 111 for valve 96 has a central opening 152 for valve spring 124.

FIG. 3 illustrates the bottom of the valve module body. Alignment pin openings are shown in FIG. 3 at 154 and 172. When the control valve module is assembled against a guide plate of the kind shown at 42 in FIG. 1, alignment pins will provide for proper indexing of the control valve module body relative to a guide plate corresponding to guide plate 42 in FIG. 1. Alignment pin openings, one of which is shown at 166, are formed in control valve module body 98 for receiving alignment pins for indexing the control valve module body 90 relative to stator core plate 92.

Annular space 128 for the main control valve 96, seen in FIG. 2, communicates with spill bore 170. This bore is only partially seen in the cross-sectional view of FIG. 2 since it generally runs radially outward at an obtuse angle from the axis of valve 96. It communicates with annular space 128 when the valve 96 is open. When stator 114 is energized, nozzle control valve 100 is unseated from valve seat 106, thereby allowing annular space 130 to communicate with spill passage 164, which, like spill passage 170, is only partially seen in FIG. 2.

A high-pressure passage corresponding to passage 26 in FIG. 1 extends from a high-pressure pumping chamber corresponding to high-pressure pumping chamber 24 in FIG. 1. It communicates with angularly disposed passages 132 and 134, seen in FIG. 2.

As indicated above, FIG. 3 shows the bottom of the control valve module body 90. The valve module body has two kidney-shaped recesses 174 and 176, which prevent cross-flow between the valve bores. FIG. 3 shows the valve bore 102 for the nozzle control valve 100. Likewise, the valve bore 98 for main control valve 96 can be seen in FIG. 3.

Passage 144 in FIG. 2 extends from the annular space 130 for nozzle control valve 100. It is an angularly drilled passage, seen also in FIG. 3. The end of the passage 144 is seen in FIG. 3.

The kidney-shaped recess 174 has a flow-restricting orifice 178, and the kidney-shaped recess 176 has a flow-restricting orifice 180. These orifices communicate with a low-pressure port (not shown) in a needle valve housing or nut of the kind seen in FIG. 1 at 87. That port would communicate with a low-pressure region, such as low-pressure region 182 seen in FIG. 1. The orifices 178 and 180 prevent a pressure buildup at the base of the control valves 96 and 100. A pressure buildup, if it were to occur, would result in an undesirable leakage from one valve region to the other, thereby interfering with the proper functioning of the valves. The orifices further prevent spill pulses from getting into the kidney-shaped recesses. Any leakage from one valve bore thus will not influence the valve in the other bore.

The recess shown at 138 at interface 94 in FIG. 2 is easily machined since the control valve module body is made as a separate element of the injector. The passages 134 and 132, for example, also are easily machined using a drilling operation. Further, notwithstanding the awkward angle of the passage 144, that passage can be easily machined prior to final assembly of injector.

The passages in the control valve module can be strategically drilled at locations of maximum material cross-section and strength.

Passages in the control valve module that intersect (e.g., passages 132 and 134) are disposed at a relative obtuse angle, which reduces the deflection of fluid passing through the passages. The drilling of these passages results in a smooth surface at the location of the intersection, and no special deburring operation (e.g. ECM) is needed. The resulting reduction of deflection of fluid in the passages improves fluid flow efficiency because of a reduction in flow disturbances.

A minimum amount of grinding is required to achieve the desired flatness of the surfaces at interface 94. The grinding operation is easier than a corresponding grinding operation for the design of FIG. 1 because the surface being ground is not at the base of a stator bore. Similarly, the desired flatness at the base surface 184, seen in FIG. 2, can be achieved by a simple grinding operation.

Complex grinding is not required in the valve bores, unlike the case of an integrated design such as that shown in FIG. 1. Further, the shims 131 and the shoulder shown at 186 in FIG. 2 facilitate fitting of the valves within the valve openings, thereby achieving a desired air gap at the armature and proper valve positioning with respect to the valve seats for the control valves 96 and 100. Easier, faster and more precise drilling and valve grinding operations thus are possible because of the separate stator core plate and control valve module of the invention.

The advantage in drilling operations is due in part to the shorter drilling distances that are needed.

Although an embodiment of the invention has been described, modifications may be made by persons skilled in the art without departing from the scope of the invention. All such modifications and equivalents thereof are intended to be covered by the following claims.

What is claim is:

1. An injector unit comprising:
a pumping chamber;
an actuator responsive to a timed engine operating parameter for pressurizing fuel in the pumping chamber;
a housing defining a high pressure fuel injection nozzle;
a high pressure fluid passage connecting the pumping chamber to the nozzle;
a control valve module for regulating fluid pressure at the nozzle, the control valve module including control valve bores with valve seats and first and second valves; and
a stator core plate independent of the control valve module having first and second actuators for displacing the first and second valves in the control valve module, each actuator having an electromagnetic stator and an armature, each valve being connected to a separate armature, and an electronic controller for governing displacement of the valves against the valve seats in the control valve bores.

2. The injector unit as defined in claim 1 wherein the control valve module includes a first housing wall, a guide plate with a second housing wall, and an indexer for maintaining alignment of the valve bores in the control valve module and the guide plate at an interface of the first and second housing walls.

3. The injector unit as defined in claim 2 wherein the indexer includes aligned apertures in each of the first and second housing walls, and pins dimensioned to be received in the aligned apertures.

4. The injector unit as defined in claim 2 wherein the control valve module and the guide plate include aligned passages, the control valve module and the stator core plate having mating third and fourth housing walls, respectively, and alignment pin apertures at an interface of the third and fourth housing walls.

5. The injector unit as defined in claim 4 wherein said passages are placed at locations of maximum material cross-section and strength, at least one pair of said passages being drilled at relative obtuse angles at locations where the passages intersect whereby fluid flow therethrough has reduced deflection.

6. The injector unit as defined in claim 1 wherein the stator core plate includes at least one armature connected to at least one valve.

7. The injector unit as defined in claim 6 wherein the stator core plate includes a spring for resiliently biasing the at least one valve to a fixed bore position.

8. The injector unit as defined in claim 7 wherein the stator core plate includes a height adjuster for defining the fixed bore position.

9. The injector unit as defined in claim 8 wherein the height adjuster comprises a shim of calibrated dimensions whereby an air gap between a stator and an armature for one of the valves is precisely controlled.

10. The injector unit as defined in claim 2 wherein recesses are formed in the first housing wall adjacent the control valve bores, each recess being vented to prevent cross flow of fluid between the valves.

11. The injector unit defined in claim 4 wherein an interface of the third and fourth housing walls is characterized by a recess in one of the third and fourth housing walls whereby communication between passages in the control valve module is established, each interface comprising a single planar surface to facilitate surface grinding, at least one pair of the passages intersecting at a location that is characterized by smooth surfaces with minimal burrs following machining.

12. An injector unit comprising:
a pumping chamber;
a plunger responsive to engine operation for pressurizing fuel in the pumping chamber;
a housing defining a high pressure fuel injection nozzle;
a high pressure fluid passage connecting the pumping chamber to the nozzle;
a control valve module for regulating fluid pressure at the nozzle, the control valve module including at least one control valve bore with a valve seat and a valve in the bore; and
a stator core plate independent of the control valve module having at least one actuator for displacing the valve in the control valve module, the actuator having an electromagnetic stator and an armature, the valve being connected to the armature, and an electronic controller for governing displacement of the valve relative to the valve seat in the control valve bore.

13. The injector unit as defined in claim 12 wherein the control valve module includes a first housing wall, a guide plate with a second housing wall, and an indexer for maintaining alignment of the passages in the valve module and the guide plate at an interface of the first and second housing walls.

14. The injector unit as defined in claim 13 wherein the control valve module and the guide plate include aligned passageways, the control valve module and the stator core plate having mating third and fourth housing walls, respectively, and aligned passages and alignment pin apertures at an interface of the third and fourth housing walls.

15. The injector unit as defined in claim 14 wherein the passages are placed at locations of maximum material cross-section and strength.

16. The injector unit as defined in claim 12 wherein the stator core plate includes at least one armature connected to at least one valve and an electromagnetic stator.

17. The injector unit as defined in claim 12 wherein the stator core plate includes a spring for resiliently biasing the valve to a fixed bore position.

18. The injector unit as defined in claim 17 wherein the stator core plate includes a height adjuster for defining the fixed bore position.

19. The injector unit as defined in claim 18 wherein the height adjuster comprises a shim of calibrated dimensions whereby an air gap between the stator and the armature for the valve is precisely controlled.

20. The injector unit as defined in claim 13 wherein recesses are formed in the first housing wall adjacent the control valve bore, the recess being vented to prevent cross flow of fluid at the interface of the first and second housing walls.

21. The injector unit defined in claim 14 wherein the interface of the third and fourth housing walls is characterized by a recess in one of the third and fourth housing walls whereby communication between passageways in the control valve module is established.
